(19) United States
(12) Patent Application Publication
(10) Pub. No.: US 2002/0188952 A1
(43) Pub. Date: Dec. 12, 2002

(54) Systems and methods for accessing interactive content via synthetic channels

(76) Inventors: Anthony F. Istvan, Snoqualmie, WA (US); James A. Billmaier, Woodinville, WA (US); Robert E. Novak, Kirkland, WA (US)

Correspondence Address: Lance A. Termes, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/877,696

(22) Filed: Jun. 8, 2001

(51) Int. Cl. G06F 3/00; H04N 5/445; H04N 7/173; G06F 13/00

(52) U.S. Cl. 725/95; 725/93; 725/39

(57) ABSTRACT

Systems and methods for delivering interactive content to viewers via the utilization of synthetic channels mimicking traditional television “broadcast” cable channels. Interactive television viewers may access and interact with the variety of interactive content provided by selecting a synthetic channel that displays, on the screen of the viewer's television set or other display device, the start or home page of a particular application, Internet site, or other content page with which the user may interact. The synthetic channels may be administered by a cable provider, and communicated to the viewer via an electronic programming guide, which may also contain a traditional cable “channel lineup.” The synthetic channels may be selected from the electronic programming guide in the same manner as if the viewer was selecting a broadcast cable channel.

### TECHNICAL FIELD

This disclosure relates generally to electronic entertainment systems, and more particularly, but not exclusively, to systems and methods for accessing interactive content in an interactive television environment. Access to the interactive content is accomplished via synthetic channels that mimic traditional television broadcast “channels,” and that are communicated to a viewer via an electronic programming guide.

### BACKGROUND

In recent years, the television has arguably become the predominant entertainment medium. With this proliferation has come a new form of communication/entertainment commonly referred to as “interactive television.” Interactive television generally comprises a video technology in which a viewer interacts with standard television programming. A typical use of interactive television includes Internet access.

Whether a television signal received by a viewer's television set takes the form of a standard broadcast, or is received via a cable connection, satellite dish, or otherwise, the typical viewer distinguishes between the variety of programming based on the concept of a “channel.” While the Federal Communications Commission-allocated broadcast channels remain effectively unchanged, the growth of the cable industry and the digitalization of television provide an ever increasing number of “channels” from which to choose, and systems, utilizing such things as optical fibers or free-space optical transmission terminals, to deliver a multitude of “channels” simultaneously.

Interactive television and the interactive content it provides have traditionally been accessed via an on-screen hierarchical menu display wherein the viewer might access or “flip through” a number of displays to locate a desired interactive content item (e.g., an Internet page). While this method of access has proven to be effective, it is also cumbersome when compared to the concept of a traditional cable channel, which the user might access via the actuation of a single button. Individuals unfamiliar with the technology, or the operation of such hierarchical menu displays may find this method of accessing interactive content difficult, frustrating, and invariably, time consuming.

### BRIEF DESCRIPTION OF THE VARIOUS VIEWS OF THE DRAWINGS

The illustrated embodiments may be better understood by reference to the accompanying drawings. In the drawings, like reference numerals refer to like parts throughout the various views of the non-limiting and non-exhaustive embodiments of the present invention, and wherein:

FIG. 1 is a pictorial block diagram illustrating an interactive television network environment in accordance with an embodiment of the invention;

FIG. 2 is a schematic block diagram of a set-top-box in accordance with an embodiment of the invention;

FIG. 3 is an illustration of an example electronic programming guide in accordance with an embodiment of the invention;

FIG. 4 is a flow diagram illustrating an embodiment of a method of accessing interactive content in an interactive television viewing environment via synthetic channels; and

FIG. 5 is a flow diagram illustrating an embodiment of a method of accessing a plurality of linked interactive content via an electronic programming guide in an interactive television viewing environment.

### DETAILED DESCRIPTION OF THE ILLUSTRATED EMBODIMENTS

The illustrated embodiments generally provide systems and methods for delivering interactive content to viewers via the utilization of synthetic channels mimicking traditional television broadcast or cable “channels.” Interactive television viewers may access and interact with the variety of interactive content provided by selecting a synthetic channel that will display, on the screen of the viewer's television set or other display device, the start or home page of a particular user application, Internet web site, or other content or system page with which the user may interact, and which may be maintained on a local server, or other storage location. The synthetic channels may be administered by a cable provider, and communicated to the viewer via an electronic programming guide (“EPG”), which may also contain a traditional cable “channel lineup.”

Other features of the illustrated embodiments will be apparent to the reader from the foregoing and the appended claims, and as the ensuing detailed description and discussion is read in conjunction with the accompanying drawings.

In the following description, numerous specific details are provided to facilitate a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout the specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout the specification are not necessarily all referring to the same embodiment. Furthermore, the particular features, structures, or characteristics may be combined in any suitable manner in one or more embodiments.

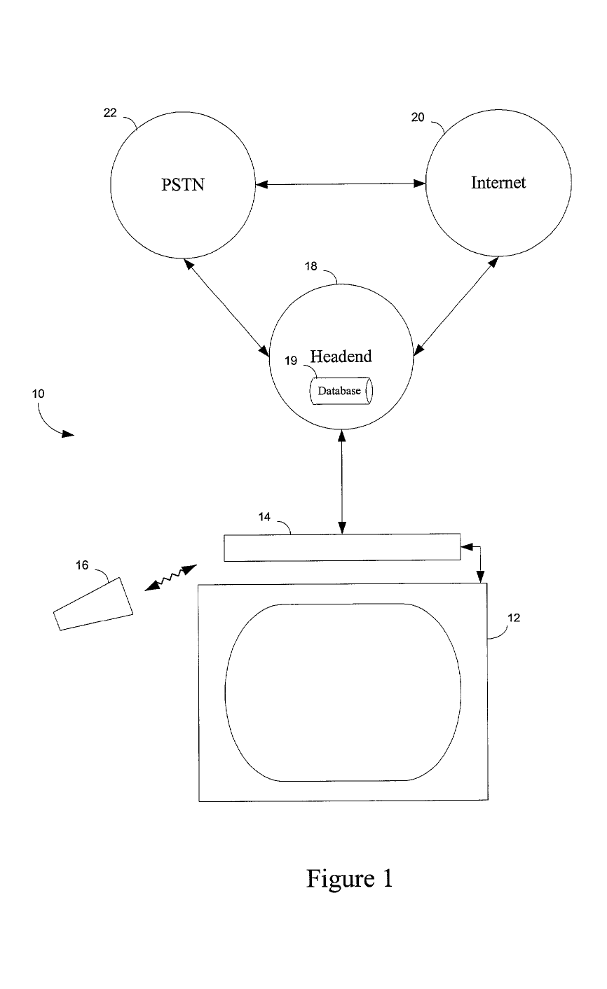

Referring now to the drawings, and in particular to FIG. 1, there is illustrated, generally at 10, an interactive television network environment in accordance with an embodiment of the invention. The interactive television network environment 10 provides access to both traditional cable channels, as well as synthetic channels, and includes, in one implementation, a television 12, a set-top-box (“STB”) 14, a remote control device 16, a headend 18, which may include a database 19, an Internet 20, and a public switched telephone network (“PSTN”) 22, or other network. The headend 18 may be connected to or comprise part of a cable television network (not shown).

In an alternate embodiment, the headend 18 may be replaced by a direct broadcast satellite (“DBS”) system operations center to facilitate the transmission of interactive television signals to a plurality of customers via a satellite transmission (herein, the term “broadcast center” is intended to refer to either a cable distribution headend, a DBS system operations center, or an equivalent). A DBS system may comprise a DBS system receiver dish comprising an 18-inch satellite dish (i.e., the antenna for receiving a satellite broadcast signal), a digital integrated receiver/decoder (“IRD”) (the equivalent of the set-top-box 14; herein, the term “client terminal” is intended to refer to either a set-top-box, an IRD, or an equivalent) that separates each channel, and decompresses and translates the digital signal for display on a viewer's television 12, and a remote control device 16.

Programming for the DBS system may be distributed, for example, by multiple high-power satellites in geosynchronous orbit, each with multiple transponders. Compression (e.g., via a Moving Pictures Experts Group (“MPEG”) standard, a set of standards for audio and video compression established by the Joint ISO/IEC Technical Committee on Information Technology) is used to increase the amount of programming that can be transmitted in the available bandwidth. In an embodiment, the IRD may communicate with the DBS system operations center via a back channel, which may comprise a telecommunications link via the PSTN 22, or via a network such as the Internet 20, or other suitable communication mechanism.

The DBS system operations center may be used to gather programming content, ensure its digital quality, and transmit the signal to the satellites. Programming may come to the DBS system operations center from content providers (e.g., CNN®, ESPN®, TBS®, HBO®, and the like) via a satellite, fiber optic cable, and/or special digital tape in various embodiments. Satellite-delivered programming is typically immediately digitized, encrypted, and up-linked to the orbiting satellites. The satellites re-transmit the signal back down to each compatible DBS system receiver dish at customer's homes and businesses.

In various embodiments, some programming may be recorded on digital videotape in the DBS system operations center to be broadcast at a future time. Before any recorded programs are viewed by customers, technicians may utilize post-production equipment to view and analyze each tape to ensure audio and video quality. Tapes may then be loaded into robotic tape handling systems, and playback may be triggered by a computerized signal sent from a broadcast automation system. Back-up videotape playback equipment will ensure uninterrupted transmission at all times.

The reader will appreciate that the television 12, the STB 14, and the remote control device 16 comprise components of the interactive television network environment 10 maintained at the location of a viewer, for example, a home, an office, or any other location at which the content provided by the interactive television network environment 10 is desired. The headend 18 comprises a component of the network environment 10 maintained by a cable provider as part of a cable television network, which may comprise a plurality of headends, networks, satellite communication equipment, and the like. The Internet 20 and the PSTN 22 comprise components of the network environment 10 that can exist as entities distinct from the cable television network itself, but provide a foundation for communicating information to and from a variety of locales that may be as close as next door, or located throughout the world.

The television 12 may be configured to display television signals in a variety of formats, including analog signals, digital television formats, or high-definition television formats. The television 12 may utilize various technologies to display the television signals, such as standard cathode ray tube technology, liquid crystal display technology, liquid plasma display technology, or projection techniques. As illustrated in FIG. 1, the television 12 may be coupled to the STB 14 in order to receive and display signals received from a cable television network via the headend 18. The reader will appreciate that although a television 12 is illustrated and described in conjunction with embodiments of the present invention, other video display devices known to those skilled in the art may also be utilized to display signals received from the cable television network or other network.

The STB 14 comprises a consumer electronics device that generally serves as a gateway between a customer's television and a broadband communication network, such as the cable television network. As its name implies, an STB 14 is typically located on top of, or in close proximity to, a customer's television 12. In general, an embodiment of the STB 14 operates in conjunction with data streams encoded using a MPEG standard. STBs 14 are also capable of communicating via two-way data streams, allowing consumers to access electronic mail, web pages, video-on-demand, or other types of interactive content.

In one embodiment, the STB 14 receives encoded signals from the cable television network via the headend 18, and decodes the signal for display on the television 12. The STB may also receive commands from the viewer via the remote control device 16, or other suitable device, and transmit those commands back to the cable television network via the headend 18, or via an alternate communication route. For example, a viewer may utilize a conventional keyboard (physically connected or remote), or may activate an on-screen keyboard to send e-mail, or for other text-based applications. In still other embodiments of the invention, the STB 14 may be connected to the Internet 20 or the PSTN 22 via connections separate from the connection to the headend 18, or may be connected to the headend 18 via a plurality of data communication channels.

In practice, a plurality of STBs may be connected to a centrally-located headend 18 that generally comprises a facility where cable television transmissions are received from a local cable television satellite downlink, or the like, and packaged together for transmission to customer homes. A number of headends 18 may be coupled together directly, or to one another through a network center, or via a separate network such as the Internet 20. In one embodiment, a database 19 containing schedule information for television programming may be stored within one or more of the headends 18, the Internet 20, or a third party system coupled in one way or another to the headend 18. The database 19 may include, for example, program channels, dates, times, critical reviews, content ratings, VCRPlus® codes, and the like. In various embodiments, copies of the database 19 can be periodically transmitted from the headend 18 to the STB 14 for local storage.

One mechanism for informing viewers (or potential viewers) of available programming accessible via the interactive television network environment 10 is through an EPG. An EPG may provide an on-screen listing of all programming and content that interactive television subscribers have available to them at any given time.

In other embodiments, a remote control device 16, or other remote display device, such as a “web pad” or computer, may be utilized to display the EPG information. The remote display device may incorporate a touch sensitive display actuateable by a viewer with a finger or other object, such as a stylus, to select “virtual” buttons or controls displayed on a screen of the remote device for channel selection, volume control, and the like. Displaying an EPG on a remote display device allows the television program currently displayed on the television to be viewed undisturbed, and provides an EPG display at a better resolution and size for viewing by the user. Embodiments of systems and methods for displaying EPG information on a remote display are disclosed in greater detail in commonly-assigned U.S. patent application Ser. No. 09/811,373, entitled INTERACTIVE, OFF-SCREEN ENTERTAINMENT GUIDE FOR PROGRAM SELECTION AND CONTROL, filed Mar. 15, 2001, and incorporated herein by reference.

Regardless of the manner or means by which the information of the EPG is displayed, the EPG, in an embodiment of the present invention, displays information related to both traditional “broadcast” cable channels, as well as synthetic channels by which a user may access both television content and interactive content, respectively.

While traditional “broadcast” cable channels include television signals corresponding to conventional television programming, such as for example, NBC®, ESPN®, Nickelodeon®, TBS®, and the like, synthetic channels generally comprise functional channels, systems channels, and content channels corresponding to interactive programming content. Functional channels provide access to computer-implemented applications that can be executed on behalf of the user, such as, for example, an event calendar, photo album, or e-mail service; system channels may comprise system pages that allow the user to administer a viewing environment via the STB 14; and content channels are informational in nature, providing such things as news, weather, and sports. The actual content of the content channels may be provided by the cable provider, or by partners working in conjunction with the cable provider to produce particular content pages that are accessible via the content channels of the cable network's EPG, for example. The content pages may comprise home pages or other pages corresponding to web sites available from the Internet 20, may comprise pages maintained and stored on a local server at, for example, the headend 18, or may comprise other browser-based or Internet Protocol (“IP”)-based content available from a network location.

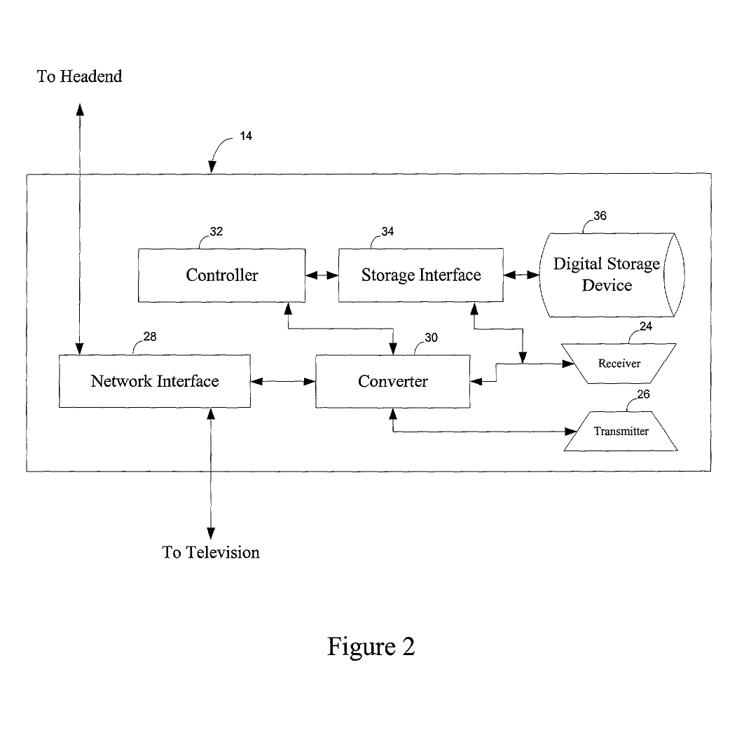

Having observed the general interaction of the various components of the interactive television network environment 10, attention may now be given to specific elements thereof, and the methods by which interactive content may be accessed via synthetic channels communicated to a viewer via an EPG. With reference now primarily to FIG. 2, the STB 14 comprises a receiver 24, such as an infrared (“IR”) or radio frequency (“RF”) receiver. In other embodiments, the receiver 24 may be configured to receive other frequencies of the electromagnetic spectrum, such as UHF, VHF, microwave, or the like. The receiver 24 can receive control signals transmitted by the remote control device 16 (see, e.g., FIG. 1) for operating the STB 14 and the television 12. The receiver may also receive other types of data, such as e-mail, and the like, for transmission to the headend 18 (see, e.g., FIG. 1).

In one implementation, the STB 14 also includes a transmitter 26, such as an IR or RF transmitter, configured, in one embodiment, to broadcast various types of information to the remote control device 16, such as television program schedule information, channel lineups, including traditional channels as well as synthetic channels, e-mail, and the like. As mentioned previously, the remote control device 16, or other similar device, may be configured to display textual or graphic information to the viewer. The remote control device 16 may also include a receiver and transmitter (not shown) similar to those components employed in the STB 14 to facilitate communication between the STB 14 and the remote control device 16.

The STB 14 also comprises a network interface 28 for providing access to the cable network via the headend 18. The network interface 28 may comprise a cable modem or the like, while in other embodiments, the functionality of the network interface 28 may be provided alternatively or in addition by a converter 30. In the illustrated embodiment, the converter 30 modulates and demodulates signals that are received or transmitted via the receiver 24 or the transmitter 26. A controller 32, for managing the operation of the STB 14, may be embodied as a microprocessor, digital signal processor, or other suitable device known in the art. The controller 32 may manage, for example, transmission and reception of signals to and from the headend 18, to and from the remote control device 16 (see, e.g., FIG. 1), or to and from a digital storage device 36 via a storage interface 34. The storage interface 34 is designed to retrieve and/or store information in the digital storage device 36, which may be a hard disk drive or other memory device.

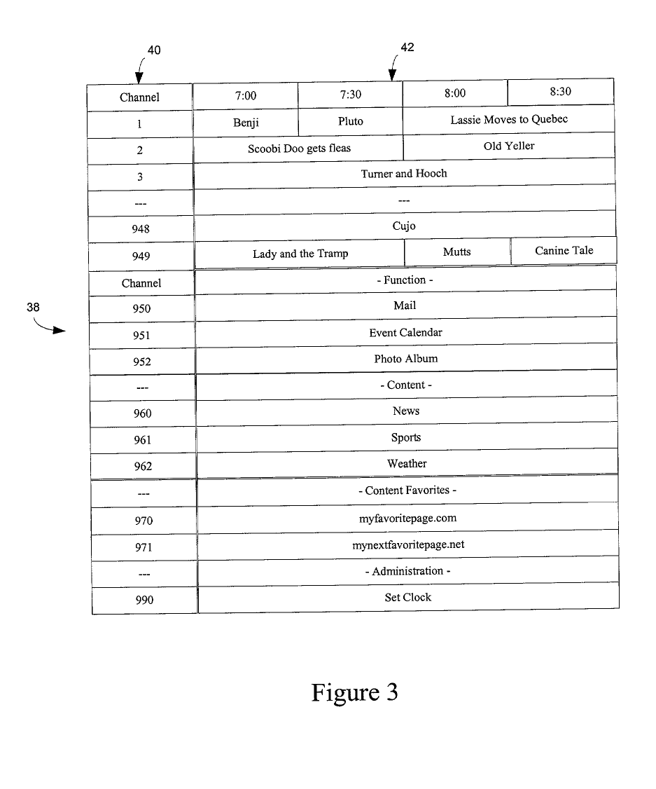

As an overview, the reader will appreciate that the synthetic channels are provided in an EPG in a manner similar to that for conventional cable channels. Each channel number is associated with, and corresponds to, a particular television signal (in the case of a conventional cable channel), or to a user application, content page, or system administration page, as the case may be, for the functional channels, content channels, or system channels, respectively, which comprise the synthetic channels. FIG. 3 is an illustration of an example EPG display 38 showing how the channel “line-up” and schedule information may be provided to a viewer for the available interactive programming content. Channels 1-949 (indicated by a channel field 40), for example, may comprise the conventional cable channels associated with television signals corresponding to NBC®, ESPN®, Nickelodeon®, TBS®, and the like, as mentioned previously, and may be followed by a current programming schedule (as indicated by a content field 42).

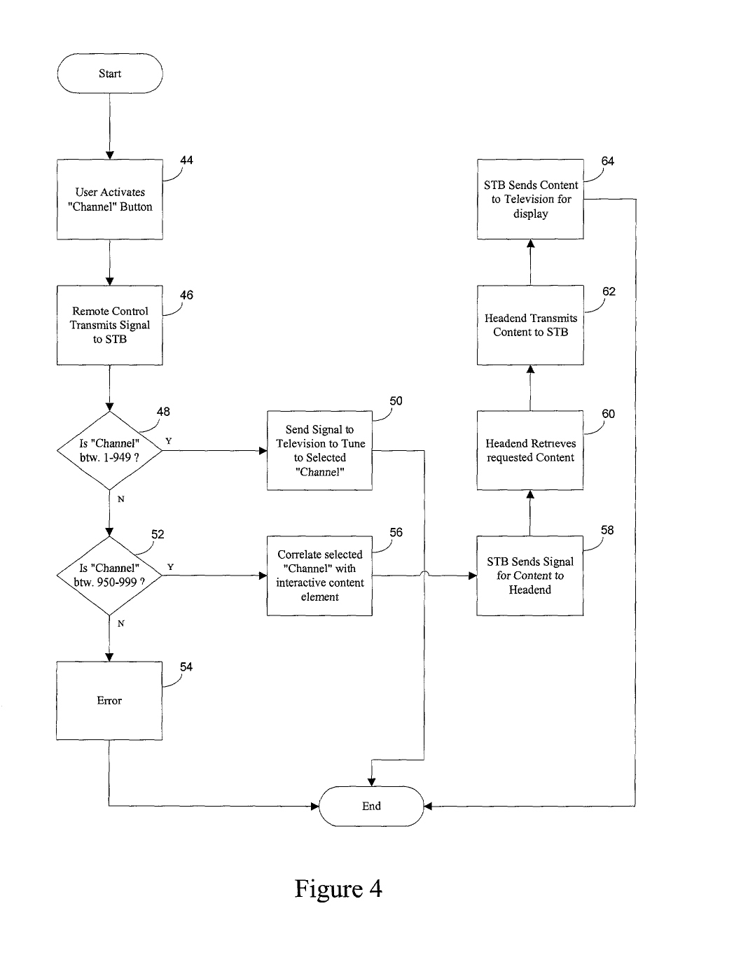

Channels 950-999, for example, may comprise the synthetic channels, and may, in an embodiment, be segregated into sections corresponding to functional channels, content channels, and/or system channels. For example, channels 950-959 may correspond to functional channels via which a user may activate an application such as an event calendar, a photo album, an e-mail service, or the like. Channels 960-969, for example, may correspond to content channels via which a user may access a content page comprised of an Internet page, or a page maintained on a local server in the headend, at some other location within the cable provider's network, or elsewhere. Channels 970-989 may, in an embodiment, comprise content pages specifically designated by a user via a unique address in a manner that is similar to designating “favorites” in a standard browser application. This process will be described in greater detail hereinbelow in conjunction with FIG. 4. Channels 990-999, for example, may correspond to system channels wherein the user administers the STB environment. It is to be appreciated that these channel number designations are merely illustrative, and that various embodiments can designate channel numbers in any suitable manner.

A user may selectively view a traditional television program, or the interactive content programming simply by actuating a button, for example, on the remote control device 16, or a button located on the STB 14 itself, to select the desired channel. Channel selection may be done by actually pressing channel number buttons on the remote control device 16, or directly by using arrow keys or the like to scroll the channels shown on the EPG display 38 and then selecting “Enter.” When an interactive content programming selection is activated, the previous television signal may, in an embodiment, continue to be displayed on the television screen as a background image. In other words, closing or exiting the interactive content programming selection will once again make entirely visible the television program that was previously being displayed on the television screen. Alternatively, or in addition, the television programming content may, when an interactive content programming selection is activated, be reduced in size and remain visible in, for example, a corner of the television screen or other display device.

With reference now primarily to an embodiment illustrated in FIG. 4, a user, seeking to activate an interactive content programming selection, activates a “channel” button at block 44, which may be located, in an embodiment, on the remote control device 16 (see, e.g., FIG. 1). The remote control device 16 transmits a signal corresponding to the selected “channel” to the STB 14 at block 46. The transmitted signal may comprise an IR or RF signal as discussed previously in regard to the transmitter and receiver components of the STB 14 and remote control device 16. The STB 14, via the controller 32 (see, e.g., FIG. 2) and/or associated software, determines (at block 48) whether the selected “channel” falls within a first predefined range, for example, 1-949 (corresponding, in the embodiment illustrated in FIG. 3, to traditional television programming content), and if so, sends a signal to the television 12 to tune to the selected television signal at block 50. At this point, the process ends, awaiting selection of the next “channel.” Tuning the television 12 to a traditional cable television signal is accomplished via conventional methods known to those skilled in the art. As such, a discussion of a process of tuning the television is beyond the scope of this invention, and will not be discussed in greater detail herein.

If the selected “channel” does not fall within the predefined range (see block 48 above), the STB 14 may, in an embodiment, next determine (at block 52) whether the selected “channel” falls within a second predefined range, for example, 950-999 (corresponding, in the embodiment illustrated in FIG. 3, to interactive content programming). The reader will appreciate that an evaluation of the second predefined range will not always be necessary. For example, where the STB 14 only accepts a three-digit “channel” number, the determination (see, e.g., block 48) as to whether the selected “channel” falls within the first predefined range may be sufficient to effectively determine whether the “channel” corresponds to traditional programming or interactive content programming.

Where additional “channels” are available or permitted beyond “999,” and where the selected “channel” falls outside the second predefined range (see, e.g., block 52), the STB 14 may indicate an “error” (see, e.g., block 54), and the “channel” selection process may end, awaiting selection of the next “channel” by the user.

If the selected “channel” falls within the second predefined range corresponding to the interactive content programming in the illustrated embodiment, the STB 14, via the controller 32 and/or associated software, next correlates (see, e.g., block 56) the selected “channel” with an interactive content element, which may comprise a user application, or a content or system administration page. In an embodiment, each interactive content element corresponds to a defined synthetic channel number, for example, a user's e-mail application may correspond to synthetic channel number 950, or a current sports content page may correspond to synthetic channel number 961 (see, e.g., FIG. 3).

After the selected “channel” has been correlated to the defined interactive content element, the STB 14 may send an uplink signal via an uplink path to the headend 18 requesting the interactive content element corresponding to the selected “channel” (see block 58). In other embodiments, the interactive content element corresponding to the selected “channel” may be broadcast from the headend 18 using a “carousel” technique, and be immediately available on the STB 14 (by, e.g., caching the content on the STB) without the necessity of a headend request. In the carousel technique, the headend 18 may be configured to automatically send updated content information to the STBs 14. Using the carousel technique, the headend 18 sends a certain number of data packets in a particular sequence by, for example, out-of-band data transfer, IP multicast, or the like, and then repeats the sequence at regular intervals.

Communications between the STB 14 and the headend 18 may be encoded in a data over cable service interface specification (“DOCSIS”) protocol, an International Telecommunications Union standard that specifies functions, and internal and external interfaces for high-speed, bidirectional transfer of digital data between cable television networks and subscribers. Other suitable data communication protocols may also be utilized. In an embodiment, a browser (such as a web browser) located at the STB 14 may be launched and used to request the interactive content or interactive content element, such as by specifying the IP address or other address from where the interactive content may be retrieved.

When the signal requesting the interactive content element is received by the headend 18, the headend 18 retrieves the requested interactive content element from, for example, a memory storage device (see, e.g., block 60), the Internet, or other network storage location, and transmits a downlink signal comprising the interactive content element to the STB 14 (see, e.g., block 62). The cable provider may utilize a cable modem termination system at the headend 18 to route traffic coming in from a group of customers on a single channel to an Internet Service Provider (“ISP”) for connection to the Internet 20. The cable provider may have servers and protocols for assigning and administering the IP addresses of the cable customer's, or may lease space to a third party ISP to carry out those functions.

The STB 14 may then receive the signal from the headend 18, comprising the interactive content element, via a downlink path, decode the signal via the network interface 28 (see, e.g., FIG. 2), and send the interactive content to the television 12 for display (see, e.g., block 64), by a browser for example. When the interactive content element requested by the STB 14, and retrieved by the headend 18 comprises a user application, the particular application can be launched and executed from, for example, the database 19 or other server located at the headend 18, or the user application may be launched from the STB 14. In the case that the interactive content element corresponds to a content page, a browser application may be launched in a similar fashion from a headend server, or from the STB 14, and the particular home or start page corresponding to the selected synthetic channel can be retrieved from the Internet 20 or a database 19 via conventional methods, such as for example, transmission control protocol (“TCP”), IP, or hypertext transfer protocol (“HTTP”), or a protocol suite combining two or more of the foregoing, as will be familiar to those skilled in the art.

While an embodiment has been described above where the STB 14 retrieves the interactive content element by requesting it through the headend 18, it is to be appreciated that the interactive content element may be retrieved without necessarily having to go through the headend 18. For instance, the STB 14 can have an independent connection to the Internet 20, such that a browser in the STB 14 can directly retrieve interactive content element(s) available from the Internet 20. In yet other embodiments, the headend 18 can perform a type of “handoff” connection where it comprises part of the uplink connection to the Internet 20, but allows the downlink connection to occur directly between the Internet 20 and the STB 14.

As indicated above, a number of the synthetic channels may be reserved for the user to assign to a particular content page. To accomplish this, the user may, in an embodiment, access a synthetic system channel wherein a user may enter a desired content page address, for example, a universal resource locator (“URL”), or other identifier, such as an IP address. In any case, the identified address can be unique to the desired content page. Software associated with the system channel may link the designated address with the next available, or specified “channel” within the reserved range of synthetic channels available. In effect, this content specific user assignment of a synthetic channel reprograms the EPG that may be displayed for the particular user. This favorites information may then be updated at a user data storage device (e.g., database 19) maintained at the headend 18, which may then provide this programming information as part of the updated EPG transmitted to the particular customer. In this manner, a “mapping” of interactive content addresses to designated channel numbers can be provided.

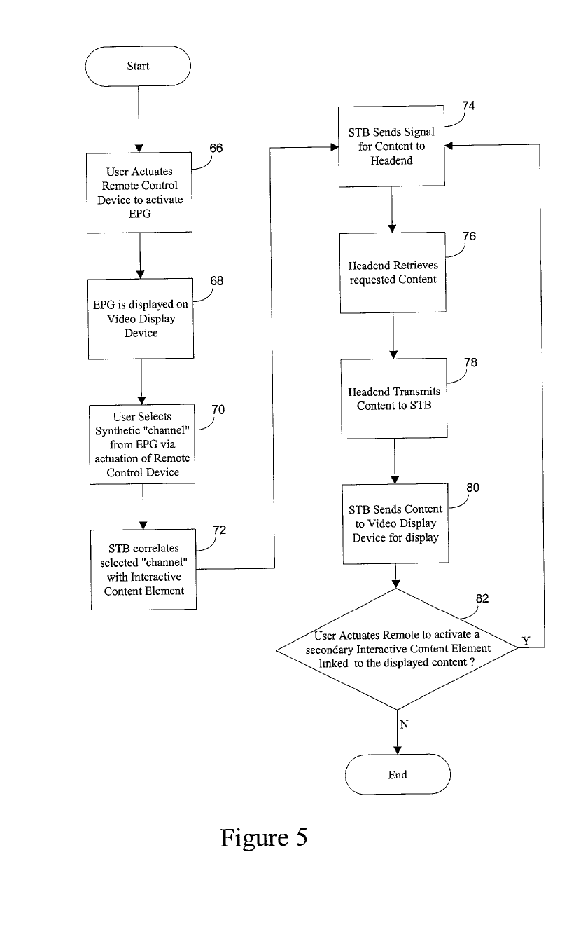

With reference now primarily to an embodiment illustrated in FIG. 5, a user, seeking to access a plurality of linked interactive content such as, for example, content pages comprising URL or other identifying address information to additional content pages, may actuate a button or buttons on a remote control device to generate a first interactive command to activate an EPG (see, e.g., block 66). The first interactive command may be received by the STB so that the EPG may be displayed on the video display device or television (see, e.g., block 68), as indicated throughout the previous discussion. The EPG may include accessible broadcast channels and accessible synthetic channels.

As indicated previously with reference to FIG. 4, a user may select a synthetic “channel” from the EPG via actuation of a button or buttons to control a cursor or scroll through a list of available content in order to select a desired interactive content element (see, e.g., block 70). Upon selecting the desired interactive content element, a second interactive command may be received by the STB, the second interactive command comprising a synthetic channel selection. The STB may then correlate the selected “channel” with a first interactive content element (see, e.g., block 72), and send a signal for the desired content to the headend, or other remote location, (see, e.g., block 74) in a manner similar to that discussed above in conjunction with FIG. 4.

The headend may then retrieve the requested content (see, e.g., block 76), and transmit the content to the STB (see, e.g., block 78) where the content is sent to the video display device to be displayed (see, e.g., block 80) for viewing by the user. At this point, the user may desire to interact with the displayed content element, or access a second interactive content element which is linked to the first interactive content element via a URL or other address identifier displayed in association with the first interactive content element (see, e.g. block 82). If the user wished to access a secondary interactive content element, the user may again actuate the remote control device to generate a third interactive command that may be received by the STB from which a signal may be sent to the headend or other location, requesting the second interactive content element (in effect, blocks 74-82 are repeated until the user no longer desires to access additional linked interactive content elements). The headend may retrieve the second interactive content element, and send it to the STB for display in a manner similar to that discussed above. Following this same pattern, a user may actuate the remote control device to generate a fourth interactive command requesting a third interactive content element, and so on, such that additional interactive commands may be utilized to access additional interactive content elements at the user's discretion.

While the invention is described and illustrated here in the context of a limited number of embodiments, the invention may be embodied in many forms without departing from the spirit of the essential characteristics of the invention. The illustrated and described embodiments, including what is described in the abstract of the disclosure, are therefore to be considered in all respects as illustrative and not restrictive. The scope of the invention is indicated by the appended claims rather than by the foregoing description, and all changes which come within the meaning and range of equivalency of the claims are intended to be embraced therein.

### Appendix A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Todd M. Becker, Reg. No. 43,487; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Thomas M. Coester, Reg. No. 39,637; Donna Jo Coningsby, Reg. No. 41,684; Florin Corie, Reg. No. 46,244; Mimi Diemmy Dao, Reg. No. 45,628; Dennis M. de Guzman, Reg. No. 41,702; Stephen M. De Klerk, Reg. No. 46,503; Michael Anthony DeSanctis, Reg. No. 39,957; Daniel M. De Vos, Reg. No. 37,813; Justin M. Dillon, Reg. No. 42,486; Sanjeet Dutta, Reg. No. 46,145; Matthew C. Fagan, Reg. No. 37,542; Tarek N. Fahmi, Reg. No. 41,402; Thomas S. Ferrill, Reg. No. 42,532; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Lawrence E. Lycke, Reg. No. 38,540; Michael J. Mallie, Reg. No. 36,591; Andre L. Marais, Reg. No. P048,095; Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; Michael A. Proksch, Reg. No. 43,021; William F. Ryann, Reg. No. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No. P47,089; Maria McCormack Sobrino, Reg. No. 31,639; Stanley W. Sokoloff, Reg. No. 25,128; Judith A. Szepesi, Reg. No. 39,393; Edwin H. Taylor, Reg. No. 25,129; Lance A. Termes, Reg. No. 43,184; John F. Travis, Reg. No. 43,203; Joseph A. Twarowski, Reg. No. 42,191; Kerry D. Tweet, Reg. No. 45,959; Mark C. Van Ness, Reg. No. 39,865; Tom Van Zandt, Reg. No. 43,219; Brent E. Vecchia, Reg. No. P48,011; Lester J. Vincent, Reg. No. 31,460; Archana B. Vittal, Reg. No. 45,182; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and James K. Okamoto, Reg. No. 40,110; Steven D. Young, Reg. No. 43,300; and James R. Thein, Reg. No. 31,710, my patent attorney with full power of substitution and revocation, to prosecute this application and to transact all business in the Patent and Trademark Office connected herewith.

### Appendix B

### Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclose information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclose all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made of record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

(e) In any continuation-in-part application, the duty under this section includes the duty to disclose to the Office all information known to the person to be material to patentability, as defined in paragraph (b) of this section, which became available between the filing date of the prior application and the national or PCT international filing date of the continuation-in-part application.

What is claimed is:

1. A method of accessing interactive content as part of an interactive television system, the method comprising:
assigning a synthetic channel to correspond to at least one interactive content element available as interactive programming content via the interactive television system;
communicating the interactive programming content, including the interactive content element and the corresponding synthetic channel, to a viewer via an electronic programming guide; and
providing selection of the synthetic channel corresponding to the interactive content element from the electronic programming guide via a user-actuateable device to access the interactive content element.

2. The method of claim 1 wherein the user-actuatable device comprises a remote control having a plurality of numbered actuatable buttons.

3. The method of claim 1 wherein the interactive content element comprises a computer-implemented user application.

4. The method of claim 1 wherein the interactive content element comprises a content page maintained at a network storage location.

5. The method of claim 3 wherein the user application comprises an e-mail service.

6. The method of claim 3 wherein the user-application comprises an event calendar.

7. The method of claim 3 wherein the user-application comprises a photo album.

8. The method of claim 4 wherein the content page comprises a page corresponding to an Internet site.

9. The method of claim 4 wherein the content page comprises a page designated by a user via a unique address.

10. The method of claim 4 wherein the content page comprises a page maintained on a local server.

11. A method of accessing interactive content as part of an interactive television viewing environment, the method comprising:
displaying an electronic programming guide including accessible broadcast channels and accessible synthetic channels on a video display device for the interactive television viewing environment;
receiving a viewer's selection of a synthetic channel by way of the displayed electronic programming guide;
correlating the selected synthetic channel to an interactive content element available by way of the interactive television viewing environment;
retrieving the interactive content element from at least one remote location; and
displaying the interactive content element on the video display device for the interactive television viewing environment.

12. The method of claim 11 wherein selection of the synthetic channel includes actuation of at least one button on a remote control device.

13. The method of claim 12 wherein selection of the synthetic channel includes selection of the synthetic channel directly from the electronic programming guide.

14. The method of claim 11 wherein correlating the selected synthetic channel to an interactive content element is accomplished via a controller executing a computer-implemented application.

15. The method of claim 11 wherein the at least one remote location comprises a database maintained at a broadcast center;
and wherein retrieving the interactive content element includes sending an uplink signal to the broadcast center, the uplink signal comprising a request for the interactive content element, and receiving a downlink signal from the broadcast center, the downlink signal comprising the interactive content element.

16. The method of claim 15 wherein the uplink signal and the downlink signal comprise communications encoded in a data over cable service interface specification protocol.

17. The method of claim 11 wherein retrieving the interactive content element from at least one remote location comprises accessing the interactive content element that is broadcast from a broadcast center using a carousel technique.

18. The method of claim 11 wherein the video display device comprises a television.

19. The method of claim 11 wherein the interactive content element comprises a computer-implemented user application.

20. The method of claim 11 wherein the interactive content element comprises a content page maintained on a server at the remote location.

21. The method of claim 11 wherein the interactive content element comprises a system page.

22. An interactive television network environment, comprising:
a television set;
a client terminal having a network interface configured to transmit and receive encoded communication signals, the client terminal being capable of being connected to the television set; and
a broadcast center, the broadcast center capable of communication with the client terminal; and
wherein the broadcast center is configured to transmit an electronic programming guide to the client terminal, the electronic programming guide including:
a listing of channels, the channels comprising cable channels and synthetic channels; and
identification of programming content corresponding to each channel; and
wherein the client terminal is further configured:
to receive a command from a viewer to select a channel from the electronic programming guide, wherein the selected channel comprises a synthetic channel;
to transmit an uplink signal to the broadcast center requesting the programming content corresponding to the selected synthetic channel;
to receive a downlink signal from the broadcast center, the downlink signal comprising the programming content; and
to transmit the programming content to the television set for display.

23. The interactive television network environment of claim 22, further comprising a remote control device, the remote control device configured to transmit the command to select a channel from the electronic programming guide.

24. The interactive television network environment of claim 22 wherein the synthetic channels comprise functional channels, content channels, or system channels.

25. The interactive television network environment of claim 24 wherein the functional channels correspond to interactive programming content, including applications that are executed on behalf of the viewer.

26. The interactive television network environment of claim 24 wherein the content channels correspond to interactive programming content, including content pages maintained at a network storage location.

27. The interactive television network environment of claim 24 wherein the system channels correspond to interactive programming content, including system pages that allow the viewer to administer a viewing environment via the client terminal.

28. An electronic programming guide, comprising:
a channel field, the channel field including a listing of available cable channels and available synthetic channels; and
a content field, the content field including a current programming schedule corresponding to each available cable channel, and an interactive content element corresponding to each available synthetic channel.

29. The electronic programming guide of claim 28 wherein the synthetic channels comprise functional channels, content channels, or system channels.

30. The electronic programming guide of claim 28 wherein the interactive content element comprises a computer-implemented user application.

31. The electronic programming guide of claim 28 wherein the interactive content element comprises a content page maintained at a network storage location.

32. The electronic programming guide of claim 31 wherein the content page comprises a home page corresponding to an Internet site.

33. The electronic programming guide of claim 31 wherein the content page comprises a page other than a home page corresponding to an Internet site.

34. The electronic programming guide of claim 31 wherein the content page comprises a page designated by a user via a unique address.

35. An article of manufacture, comprising:
a computer-readable medium containing a set of instructions to:
transmit an electronic programming guide from a broadcast center to a client terminal, the electronic programming guide comprising:
a channel field, the channel field including a list of available cable channels and available synthetic channels; and
a content field, the content field including a current programming schedule corresponding to each available cable channel, and an interactive content element corresponding to each available synthetic channel;
receive an uplink signal from the client terminal, the signal comprising a request for an interactive content element;
retrieve the interactive content element from a memory storage device; and
transmit a downlink signal to the client terminal, the downlink signal comprising the interactive content element.

36. The article of manufacture of claim 35 wherein the interactive content element comprises a computer-implemented user application.

37. The article of manufacture of claim 35 wherein the interactive content element comprises a content page maintained at a network storage location, including a server.

38. A method of accessing interactive content as part of an interactive television viewing environment, the method comprising:
receiving a first interactive command from a remote control device to activate an electronic programming guide;
displaying the electronic programming guide including accessible broadcast channels and accessible synthetic channels on a video display device for the interactive television viewing environment;
receiving a second interactive command from the remote control device to select a synthetic channel by way of the displayed electronic programming guide;
correlating the selected synthetic channel to a first interactive content element available by way of the interactive television viewing environment;
retrieving the first interactive content element from at least one remote location;
displaying the first interactive content element on the video display device for the interactive television viewing environment;
providing for interaction with the interactive content element by way of commands received from the remote control device;
receiving a third interactive command from the remote control device to link to a second interactive content element, the second interactive content element linked to the first interactive content element;
retrieving the second interactive content element from at least one remote location;
displaying the second interactive content element on the video display device for the interactive television viewing environment;
receiving a fourth interactive command from the remote control device to link to a third interactive content element, the third interactive content element linked to the second interactive content element;
retrieving the third interactive content element from at least one remote location; and
displaying the third interactive content element on the video display device for the interactive television viewing environment.

39. The method of claim 38, further comprising:
receiving at least one additional interactive command from the remote control device to link to at least one additional interactive content element, the at least one additional interactive content element linked to a previous interactive content element;
retrieving the at least one additional interactive content element from at least one remote location; and
displaying the at least one additional interactive content element on the video display device for the interactive television viewing environment.
